(19) United States
(12) Patent Application Publication
(10) Pub. No.: US 2025/0392747 A1
(43) Pub. Date: Dec. 25, 2025

(54) INTER CODING USING DEEP LEARNING IN VIDEO COMPRESSION

(71) Applicant: DOLBY LABORATORIES LICENSING CORPORATION

(72) Inventors: Jay Nitin Shingala, Bangalore (IN); Arunkumar Mohananchettiar, Bengaluru (IN); Pankaj Sharma, Bengaluru (IN); Arjun Arora, Sunnyvale, CA (US); Tong Shao, Sunnyvale, CA (US); Peng Yin, Ithaca, NY (US)

(73) Assignee: DOLBY LABORATORIES LICENSING CORPORATION, (US)

(21) Appl. No.: 18/878,071

(22) PCT Filed: Jun. 23, 2023
(86) PCT No.: PCT/US2023/026132

§ 371 Date: Dec. 23, 2024

(30) Foreign Application Priority Data
Jun. 29, 2022 (IN) 202241037461
Apr. 11, 2023 (IN) 202341026932

(51) Int. Cl. H04N 19/573; H04N 19/159; H04N 19/172; H04N 19/70

(52) U.S. Cl. CPC H04N 19/573; H04N 19/159; H04N 19/172; H04N 19/70

(57) ABSTRACT

Methods, systems, and bitstream syntax are described for inter-frame coding using end-to-end neural networks used in image and video compression. Inter-frame coding methods include one or more of: joint luma-chroma motion compensation for YUV pictures, joint luma-chroma residual coding for YUV pictures, using attention layers, enabling temporal motion prediction networks for motion vector prediction, using a cross-domain network which combines motion vector and residue information for motion vectors decoding, using the cross-domain network for decoding residuals, using weighted motion-compensated inter prediction, and using temporal only, spatial only, or both temporal and spatial features in entropy decoding. Methods to improve training of neural networks for inter-frame coding are also described.

### CROSS-REFERENCE TO RELATED APPLICATIONS

This application claims the benefit of priority to Indian Provisional Patent Application No. 202241037461 filed Jun. 29, 2022 and Indian Provisional Patent Application No. 202341026932 filed Apr. 11, 2023, each of which is incorporated by reference in its entirety.

### TECHNOLOGY

The present document relates generally to images. More particularly, an embodiment of the present invention relates to inter-coding using deep learning in video compression.

### BACKGROUND

In 2020, the MPEG group in the International Standardization Organization (ISO), jointly with the International Telecommunications Union (ITU), released the first version of the Versatile Video Coding standard (VVC), also known as H.266. More recently, the same joint group (JVET) and experts in still-image compression (JPEG) have started working on the development of the next generation of coding standards that will provide improved coding performance over existing image and video coding technologies. As part of this investigation, coding techniques based on artificial intelligence and deep learning are also examined. As used herein the term “deep learning” refers to neural networks having at least three layers, and preferably more than three layers.

As appreciated by the inventors here, improved techniques for the coding of images and video based on neural networks are described herein.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF THE DRAWINGS

An embodiment of the present invention is illustrated by way of example, and not in way by limitation, in the figures of the accompanying drawings and in which like reference numerals refer to similar elements and in which:

FIG. 1 depicts an example framework for using neural networks in video coding;

FIG. 2A depicts an example of separate luma-chroma motion compensation (MC) networks in YUV420 video coding;

FIG. 2B depicts an example of a joint luma-chroma motion compensation (MC) networks in YUV420 video coding;

FIG. 2C depicts an example neural-network (NN) implementation of the joint luma-chroma MC networks in YUV420 video coding depicted in FIG. 2B;

FIG. 3A depicts an example neural-network model for end-to-end image and video coding according to prior art;

FIG. 3B depicts an example neural-network model for end-to-end image and video coding according to an embodiment of this invention;

FIG. 3C depicts an example of an adaptation block;

FIG. 4A depicts an example NN for temporal motion-vector prediction according to an embodiment of this invention;

FIGS. 4B and 4C depict examples of applying flow prediction in temporal, delta, motion vector coding for P-frames and B-Frames respectively;

FIG. 4D depicts an example of a multi-frame motion prediction network with warping alignment, according to an embodiment of this invention;

FIG. 5A depicts a network architecture for cross-domain coding of motion vectors using previous reconstructed image data, according to an embodiment of this invention;

FIG. 5B depicts a network architecture for cross-domain coding of residual data using reconstructed motion vectors, according to an embodiment of this invention;

FIG. 6 depicts a network architecture for a temporal-spatial entropy model according to an embodiment of this invention; and

FIG. 7 depicts an example architecture for weighted motion compensated Inter prediction according to an embodiment of this invention.

### DESCRIPTION OF EXAMPLE EMBODIMENTS

Example embodiments on inter-coding when using neural networks in image and video coding are described herein. In the following description, for the purposes of explanation, numerous specific details are set forth in order to provide a thorough understanding of the various embodiments of present invention. It will be apparent, however, that the various embodiments of the present invention may be practiced without these specific details. In other instances, well-known structures and devices are not described in exhaustive detail, in order to avoid unnecessarily occluding, obscuring, or obfuscating embodiments of the present invention.

### SUMMARY

Example embodiments described herein relate to image and video coding using neural networks. In an embodiment, a processor receives a coded video sequence and high level syntax indicating that inter-coding adaptation is enabled for decoding a current picture, the processor:
parses the high-level syntax for extracting inter-coding adaptation parameters; and
decodes the current picture based on the inter-coding adaptation parameters to generate an output picture, wherein the inter-coding adaptation parameters comprise one or more of:
a joint luma-chroma motion compensation enabled flag, indicating that a joint luma-chroma motion compensation network is used in decoding when input pictures are in a YUV color domain;
a joint luma-chroma residual coding enabled flag, indicating that a joint luma-chroma residue network is used in decoding when the input pictures are in the YUV color domain;
an attention layer enabled flag indicating that attention network layers are used in decoding;
a temporal motion prediction enabled flag, indicating that temporal motion prediction networks are used for motion vector prediction in decoding;
a cross-domain motion vector enabled flag, indicating that a cross-domain network which combines motion vector and residue information is used to decode motion vectors in decoding;
a cross-domain residue enabled flag, indicating that a cross-domain network which combines motion vector and residue information is used to decode residuals in decoding; and
a temporal-spatial-entropy flag indicating whether entropy decoding uses only spatial features, only temporal features, or a combination of spatial and temporal features.

In a second embodiment, in a system comprising a processor to train neural networks for inter-frame coding, the processor may employ one or more of:
large motion training, wherein for training sequences with n total pictures, large motion training is employed using a random P-frame skip from 1 to n−1;
temporal distance modulated loss, wherein in computing rate-distortion loss as

$$Loss = w * lambda * MSE + Rate ,$$

where Rate denotes achieved bit rate and MSE measures a distortion between an original picture and a corresponding reconstructed picture, weight parameter “w” is initialized based on temporal inter frame distance as:

$$w = \{ \begin{matrix}1 , & t = 0 ( Intraframe ) \\ min ( 1 , 0.2 * t + {w}_{i} ) , & for t \geq 1 ( inter frame ) , {w}_{i} ϵ [ 0 , 1 ]\end{matrix} ,$$

where index i denotes iteration count over N training iterations.

In a third embodiment, a method is presented to process with one or more neural-networks uncompressed video frames, the method comprising:
generating motion vector and spatial map information (α) for an uncompressed input video frame (xₜ) based on a sequence of uncompressed input video frames that include the uncompressed input video frame;
generating a motion-compensated frame ( [symbol] ) based at least on a motion compensation network and reference frames used to generate the motion vector information;
applying the spatial map information to the motion-compensated frame to generate a weighted motion-compensated frame;
generating a residual frame by subtracting the weighted motion-compensated frame from the uncompressed input video frame;
generating a reconstructed residual frame ( [symbol] ) based on residual encoder analysis and a decoder synthesis network, wherein the residual encoder analysis network generates an encoded frame based on a quantization of the residual frame; and
generating a decoded approximation of the encoded frame by adding the weighted motion-compensated frame to the reconstructed residual frame.

### Example Coding Model Using Deep Learning

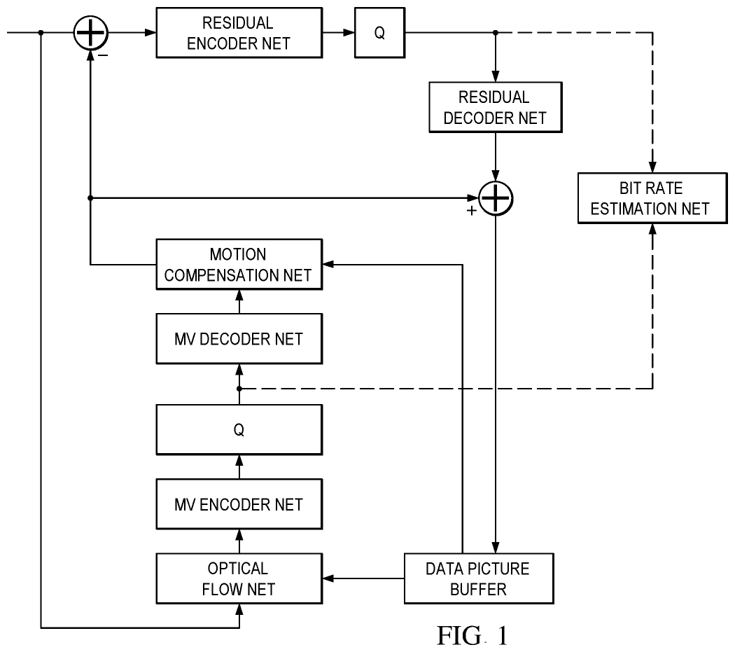

Deep learning-based image and video compression approaches are increasingly popular, and it is an area of active research. FIG. 1 depicts an example of a basic deep-learning based framework (Ref. [1]). It contains several basic components (e.g., motion compensation, motion estimation, residual coding, and the like) found in conventional codecs, such as advanced video coding (AVC), high-efficiency video coding (HEVC), versatile video coding (VVC), and the like. The main difference is that all those components are using a Neural Network (NN) based approach, such as a motion vector (MV) decoder network (net), a motion compensation (MC) net, a residual decoder net, and the like. The framework also includes several encoder only components, such as an optical flow net, an MV encoder net, a residual encoder net, quantization, and the like. Such a framework is typically called an end-to-end deep-learning video coding (DLVC) framework.

Note that this end-to-end Deep Learning (DL) network, unlike traditional encoder architectures, does not have an inverse quantization block (inverse Q). Such end-to-end networks do not require inverse Q. This is because a simple half-rounding-based quantization of latents is done on the encoder size, which does not require any inverse Q on the decoder side. The network is trained for different lambdas (different QPs) (e.g., Loss=lambda*MSE+Rate) to generate one model per each lambda.

Compared to traditional coding schemes, state of the art DLVC approaches can have similar coding performance for images, but still have a big gap for inter coding when compared to VVC. Embodiments described herein will focus on improving neural-networks training, coding efficiency, and coding complexity, for inter-frame (or Inter) coding.

### YUV 4:2:0 Coding

In typical DLVC implementations, the framework of FIG. 1 operates on images in the RGB domain. Given the correlation between chroma components, it may be more efficient to operate in a luma-chroma space, such as YUV, YCbCr, and the like, in a 4:2:0 domain (denoted simply, and without limitation, as YUV420), where 4:2:0 denotes that compared to luma, chroma components are subsampled by a factor of two in both the horizontal and vertical resolutions.

To operate in the YUV420 domain, several modifications are proposed to enable YUV420 coding more efficiently. As luma and chroma motion are highly correlated, in an embodiment, the motion estimation and motion coding of luma and chroma is jointly done using a modified YUV Optical Flow network and MV Encoder Net-MV Decoder Net respectively. However, motion compensation and residual coding of luma and chroma components for YUV420 can be handled in multiple ways as follows
Use separate luma and chroma motion compensation (MC) networks or use a joint luma-chroma MC network;
Use separate luma and chroma residual coding networks or use a joint luma-chroma residual coding network

### Separate and Joint Motion Compensation (MC) Networks for YUV420 Coding

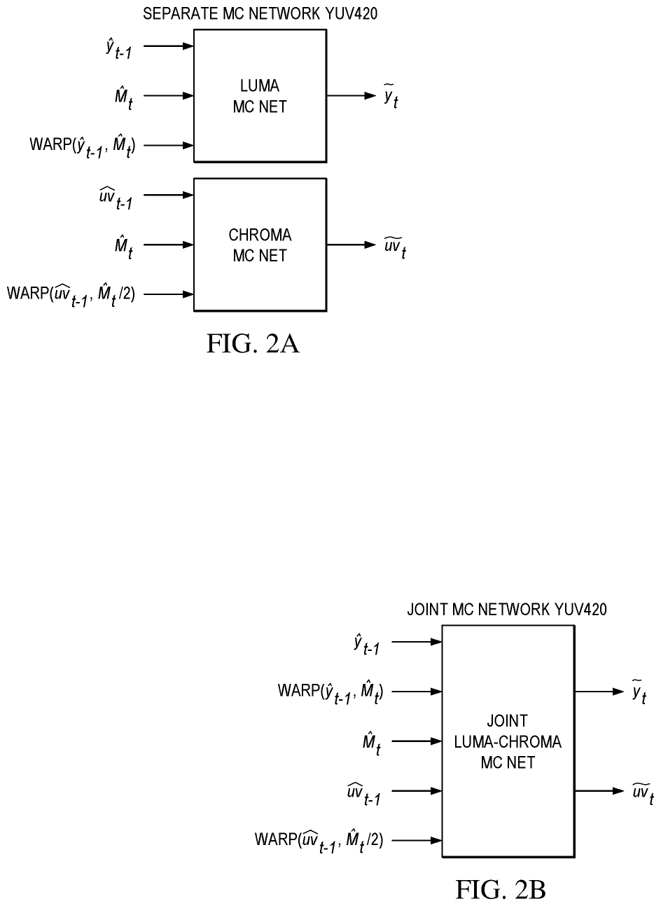

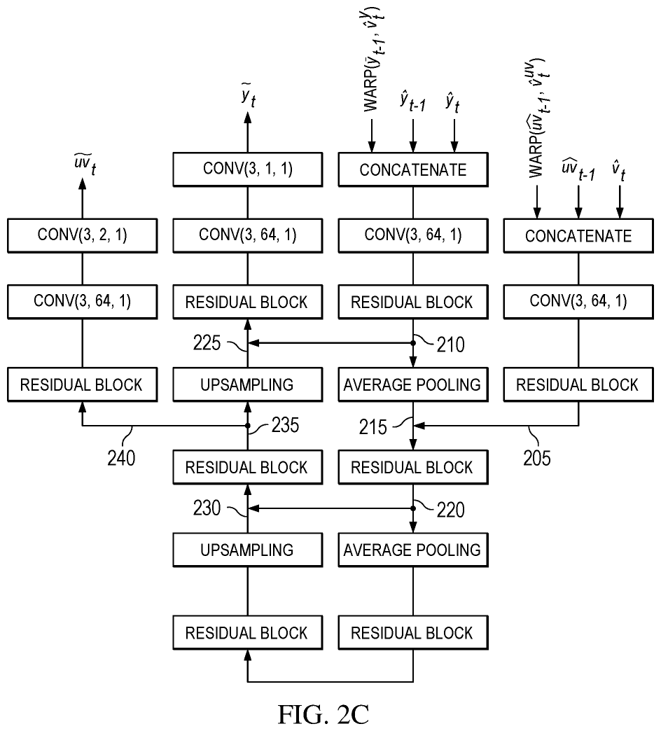

MC networks designed for RGB images assume that all image channels are of the same dimension. For YUV420 inter frames, separate MC networks can be devised to suit the dimensions of the Y and UV channels as shown in FIG. 2A. But this has additional complexity, it also has the risk that the joint information present in the Y and UV channels is not effectively utilized and that the channels may be motion compensated slightly differently leading to artifacts in the reconstructed images. The inputs to Luma MC Net in the separate MC network of FIG. 2A are the decoded motion \hat{M}ₜ of the current frame, the luma component of reference frame ŷₜ₋₁, and the bilinear interpolated luma prediction frame denoted by warp (ŷₜ₋₁, \hat{M}ₜ). As used herein, the term “warp” or “warping” denotes a bilinear interpolation of reference frame samples using decoded flow. The Luma MC Net output is the motion compensated luma frame \tilde{y}ₜ. Similarly, the inputs to chroma MC net of the separate MC network in FIG. 2A are the decoded motion \hat{M}ₜ of the current frame, chroma components of reference frame [symbol] ₜ₋₁, and the bilinear interpolated chroma prediction components warp ( [symbol] ₜ₋₁, \hat{M}ₜ/2) using down sampled and down scaled chroma motion \hat{M}ₜ/2. The Chroma MC Net then outputs the motion compensated chroma components [symbol] ₜ.

A joint luma-chroma MC network, for example, as shown in FIG. 2B, can effectively utilize cross dependencies, provided dimensions of Y and UV references and warped frame channels are handled appropriately. The inputs to joint Luma-Chroma MC Net in FIG. 2B are the decoded motion \hat{M}ₜ of the current frame, the luma component of reference frame ŷₜ₋₁, the bilinear interpolated luma prediction frame denoted by warp (ŷₜ₋₁, \hat{M}ₜ), chroma components of reference frame [symbol] ₜ₋₁, and the bilinear interpolated chroma prediction components warp ( [symbol] ₜ₋₁, \hat{M}ₜ/2) using down sampled and down scaled chroma motion \hat{M}ₜ/2. The joint Luma-Chroma MC Net outputs the motion compensated luma component \tilde{y}ₜ and chroma components [symbol] ₜ.

FIG. 2C depicts an example embodiment of a neural network for joint luma-chroma MC. Typical MC neural networks (as in Ref. [1] and Ref. [7]) consist of an initial convolutional layer with a residual block which operates on the current frame spatial dimension, followed by a) a series of average pooling layers that reduce the spatial dimension of prediction frame features by a factor of 2 and b) residual blocks. The predicted frame features of lower spatial dimensions are then processed using a series of residual blocks, upsampled and added back to higher dimensional features for enhancing quality of inter-prediction. Since chroma components have half the resolution of luma for YUV420, the motion compensation of the luma and chroma inter prediction components is performed in a unified way by merging the chroma channels at the appropriate pooling layer of luma where their resolutions match. The proposed method gives computational savings and improved performance and at the same time reduces memory usage.

In the joint Luma-Chroma MC net of FIG. 2C, luma and chroma bilinear interpolated frames are partially processed independently using convolution and residual block in the initial stages (prior to 205 and 210). The chroma inter-prediction features (205) are then added to luma inter-prediction after the first luma pooling layer (215) as chroma is half the luma resolution. This ensures that luma and chroma prediction are jointly processed thereafter that can reduce complexity compared to the separate MC network and also exploit cross-channel dependencies. Chroma inter prediction features are separated from the joint inter prediction features prior to the final upsampling layer (235) and processed separately from (240) to output the final motion compensated chroma inter prediction [symbol] ₜ. Luma inter prediction features are processed independently after the final upsampling (layer 225) to output the final motion compensated luma inter-prediction \tilde{y}ₜ.

As used in FIG. 2C, the term Conv(K, C, S) denotes a convolutional network with a K×K kernel, C output channels, and stride S (S=1 means there is no up-sampling or down-sampling). The number of inputs is not explicitly noted, since the notation assumes that the number of outputs from a given stage is equal to the number of inputs into the next stage. For example, in column 240, Conv(3, 64, 1) is followed by Conv(3,2,1). This means the last layer, Conv(3,2,1), receives 64 input channels from the previous layer, Conv(3,64,1), and outputs two channels, which correspond to the chroma MC predicted output [symbol] ₜ.

### Separate and Joint Residue Coding Networks for YUV420 Coding

Similarly to the MC network considerations, the luma and chroma residue of inter frames can be coded separately or jointly. Separate residue coding can improve coding performance for chroma. However, separate residue coding can increase the complexity and can increase coding overhead if possible cross correlations in luma and chroma residue channels are not effectively utilized. Separate luma/chroma residue coding network is novel for inter-frame coding. A joint luma-chroma residue coding network can effectively utilize cross dependencies of residue, while at the same time reducing the complexity of residue network and entropy coding. Current joint residue coding architecture is based on Refs [5-6].

### Adding Attention Layers in Inter-Coding

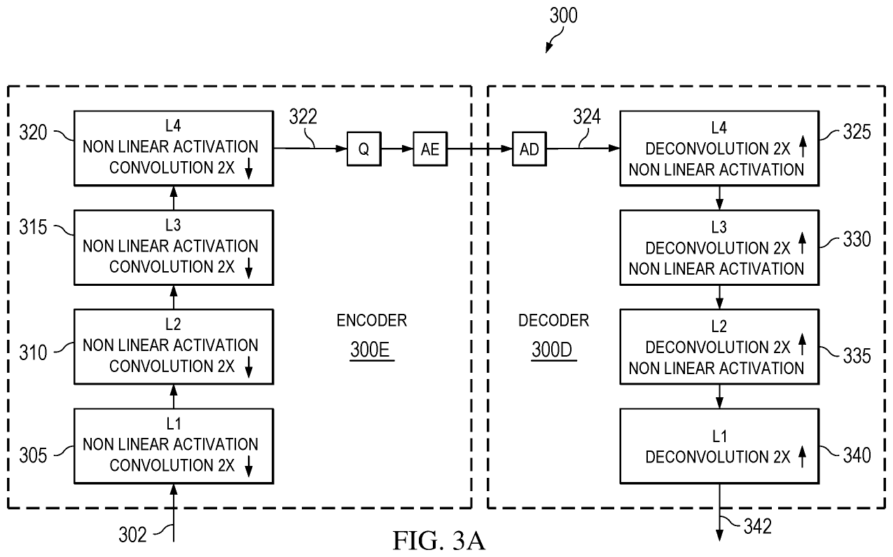

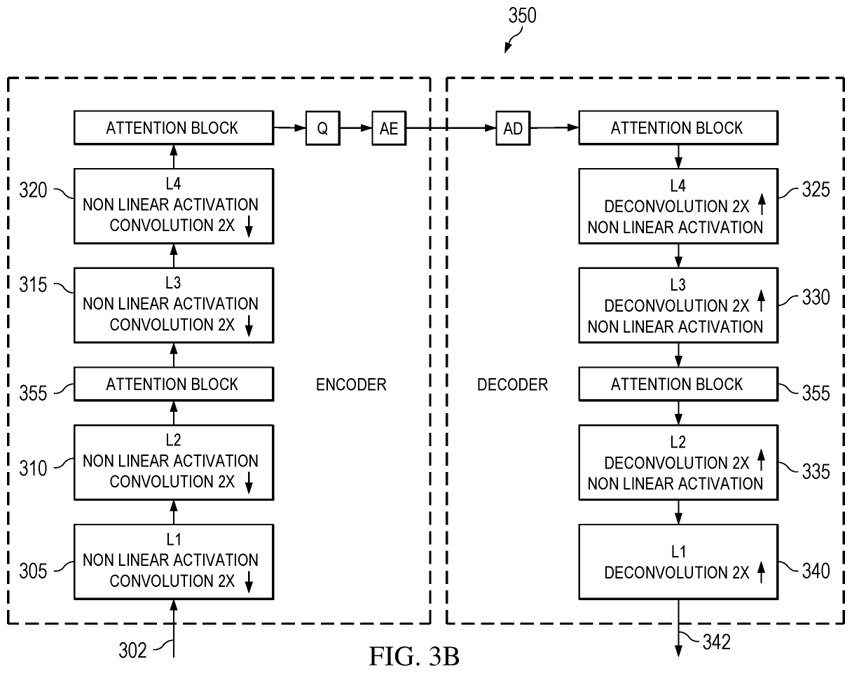

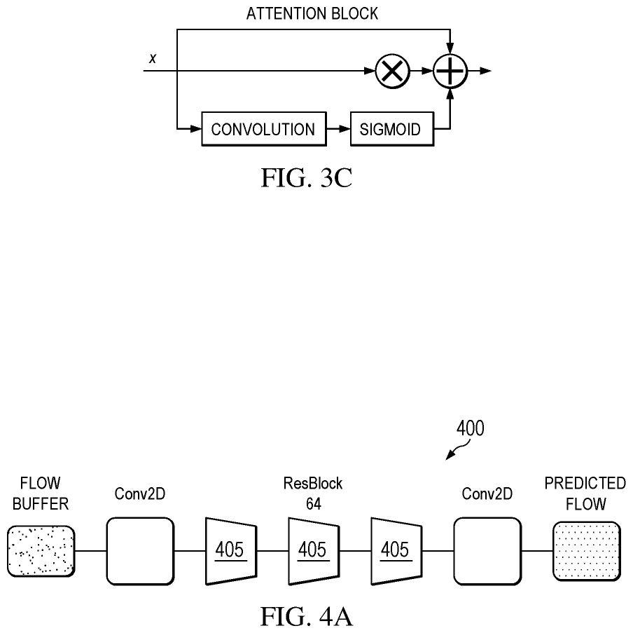

FIG. 3A depicts an example of a process pipeline (300) for video coding (Ref. [7]) using a four-layer neural network architecture for the coding and decoding of latent features. As used herein, the terms “latent features” or “latent variables” denote features or variables that are not directly observable but are rather inferred from other observable features or variables, e.g., by processing the directly observable variables. In image and video coding, the term ‘latent space’ may refer to a representation of the compressed data in which similar data points are closer together. In video coding, examples of latent features include the representation of the transform coefficients, the residuals, the motion representation, syntax elements, model information, and the like. In the context of neural networks, latent spaces are useful for learning data features and for finding simpler representations of the image data for analysis.

As depicted in FIG. 3A, given input images x (302) at an input h×w resolution, in an encoder (300E), the input image is processed by a series of convolution neural network blocks (also to be referred to as convolution networks or convolution blocks), each followed by a non-linear activation function (305, 310, 315, 320). At each such layer (which may include multiple sub-layers of convolutional networks and activation functions), its output is typically reduced (e.g., by a factor of 2 or more, typically referred to as “stride,” where stride=1 has no down-sampling, stride=2 refers to down-sampling by a factor of two in each direction, etc.). For example, using stride=2, the output of the L1 convolution network (305) will be h/2×w/2. The final layer (e.g., 320) generates output latent coefficients y (322), which are further quantized (Q) and entropy-coded (e.g., by arithmetic encoder AE) before being sent to decoder (300D). A hyper-prior network and a spatial context model network (not shown) are also used for generating the probability models of the latents (y).

In a decoder (300D), the process is reversed. After arithmetic decoding (AD), given decoded latents ŷ (324), a series of deconvolution layers (325, 330, 335, 340), each one combining deconvolution neural network blocks and non-linear activation functions, is used to generate an output x (342), approximating the input (302). In the decoder, the output resolution of each deconvolution layer is typically increased (e.g., by a factor of 2 or more), matching the down-sampling factor in the corresponding convolution level in the encoder 300E so that input and output images have the same resolution.

In an embodiment, as depicted in FIG. 3B, for the coding and decoding of P and B frames it is proposed to add “attention blocks.” Attention blocks (e.g., block 355), are used to enhance certain data more than other. As an example, an attention block may be added after two layers. In another embodiment, one can add an attention block after each layer; however, improvement in performance may not justify the increase in complexity.

The reason behind using adaptation blocks is that conventional video codecs significantly benefit from their block level adaptation to the local image/video characteristics. Thus, DL VC should benefit from local adaptation too. Attention blocks are one of the ways the layers can be adapted locally by weighing the filter responses with spatially varying weights which are learned end-to-end along with the filters. The attention blocks can also be applied to the MV net, and/or the Residue net, and/or the MC net, and the like. Their use in a specified neural network can be signalled to a decoder using high-level syntax elements. Examples of such syntax elements are provided later on in this specification. Using the proposed architecture, experimental results using YUV420 data have shown BD rate improvements between 10-14% for Y and 0-26% for U or V.

### Temporal Motion (Flow) Prediction

In the current P and B frame models, the total bits spent for coding the motion information and residue information represent the majority of the total bitrate. The motion field is correlated both temporally and spatially. In Ref. [1], the motion field generated by an optical flow network makes use of the spatial correlations; however, the temporal correlations have not been exploited. In Ref. [4], temporal information is explored using multiple previous decoded frames as input. In an embodiment, it is proposed to explore temporal correlation in DLVC.

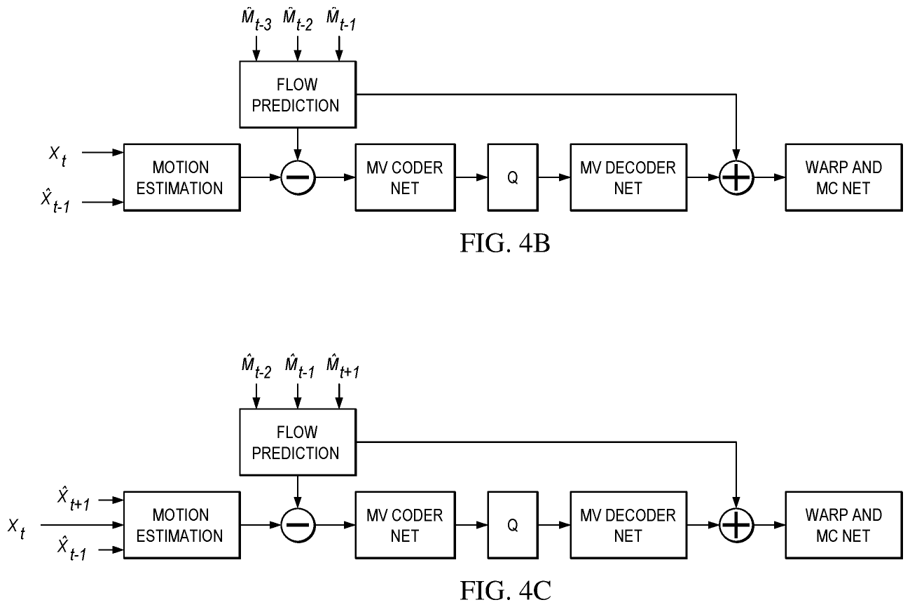

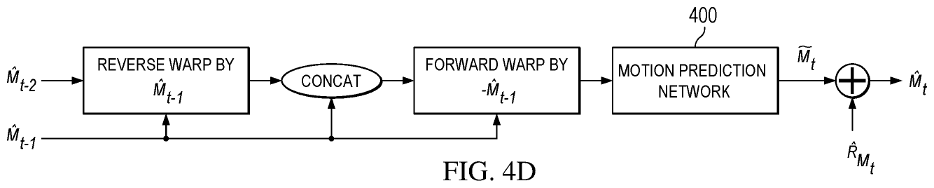

In an example embodiment, it is proposed to use temporal information based on a flow prediction network that takes as input motion fields for one or more previous frames. Experimental results show that using two frames can achieve a good tradeoff between complexity and performance, about 2% BDrate gain. FIG. 4A depicts an example of a NN for temporal MV prediction.

As depicted in FIG. 4A, the proposed NN (400) includes a flow buffer, a convolutional 2D network, a series of ResBlock 64 layers (405), and a final convolutional 2D network that are used for current frame motion prediction using the decoded flow of previously decoded frames.

FIGS. 4B and 4C depict examples of applying flow prediction in temporal, delta, motion vector coding for P-frames and B-Frames respectively. FIG. 4B shows temporal motion prediction for P-frame Xₜ referring to \hat{X}ₜ₋₁ using decoded flow \hat{M}ₜ₋₁, \hat{M}ₜ₋₂, \hat{M}ₜ₋₃ of three past (L0) reference frames assuming no hierarchical P-frame layers. FIG. 4C shows temporal motion prediction for B-frame Xₜ referring to [\hat{X}ₜ₋₁, \hat{X}ₜ₊₁ [symbol] using decoded flow \hat{M}ₜ₋₂, \hat{M}ₜ₋₁, \hat{M}ₜ₊₁ of past (L0) and future (L1) reference frames assuming no hierarchical B-frame layers. On the encoder side, temporal predicted motion flow is subtracted from the motion estimated flow and delta motion is coded using MV Coder Net. On the decoder side, MV Decoder Net decodes the delta motion and adds back the temporal prediction motion to reconstruct the final motion \hat{M}ₜ. The decoded flow is used to warp the reference frames using bilinear interpolation and final inter-prediction using MC Net.

Even though the architecture of FIG. 4A yields coding gain, the prediction might be suboptimal because, in the presence of significant amounts of motion, the prior two motion fields and the current frame may not spatially correspond to each other, and a network of limited receptive field size may have difficulty in inferring the spatial correspondence and internally aligning them to make a good prediction of the current motion field. To address this limitation, in another embodiment, it is proposed aligning the motion fields before giving them as input to the prediction network. If the motion fields at the previous two instants and the current instant are denoted as \hat{M}ₜ₋₂, \hat{M}ₜ₋₁, and \hat{M}ₜ respectively in the chronological order, \hat{M}ₜ₋₂ can be aligned to \hat{M}ₜ₋₁ by backward warping it by flow field \hat{M}ₜ₋₁ to give \hat{M}_{t-2,warped}. The concatenation of \hat{M}_{t-2,warped} and \hat{M}ₜ₋₁ need to be aligned to the current frame, and it can be done by estimating an approximate motion field between instants t−1 and t. Assuming that the motion from instant t−1 to t is of the same magnitude as the motion from instant t−1 to t−2, the aligned, concatenated flow field can be obtained by forward displacing it by this estimate of motion from t−1 to t, −\hat{M}ₜ₋₁. The displaced flow is used as input to the motion predictor network. FIG. 4D depicts the proposed motion predictor network. The motion predictor consists of a sequence of three residual layers: a reverse warp by \hat{M}ₜ₋₁, a forward wrap by −\hat{M}ₜ₋₁, and a motion prediction network (400) as in FIG. 4A. In FIG. 4D, \hat{R}_{M}_{ₜ} denotes the quantized motion vector delta value at the output of the MV DecoderNet block in FIGS. 4B and 4C.

### Cross-Domain Fusion for Motion and Residue Coding

In Ref. [1], motion and residue coding are performed independently. In an embodiment, it is proposed to take advantage of potential cross-correlation of motion and residual features. For example, motion discontinuity at object boundaries can be used to code residue features more effectively.

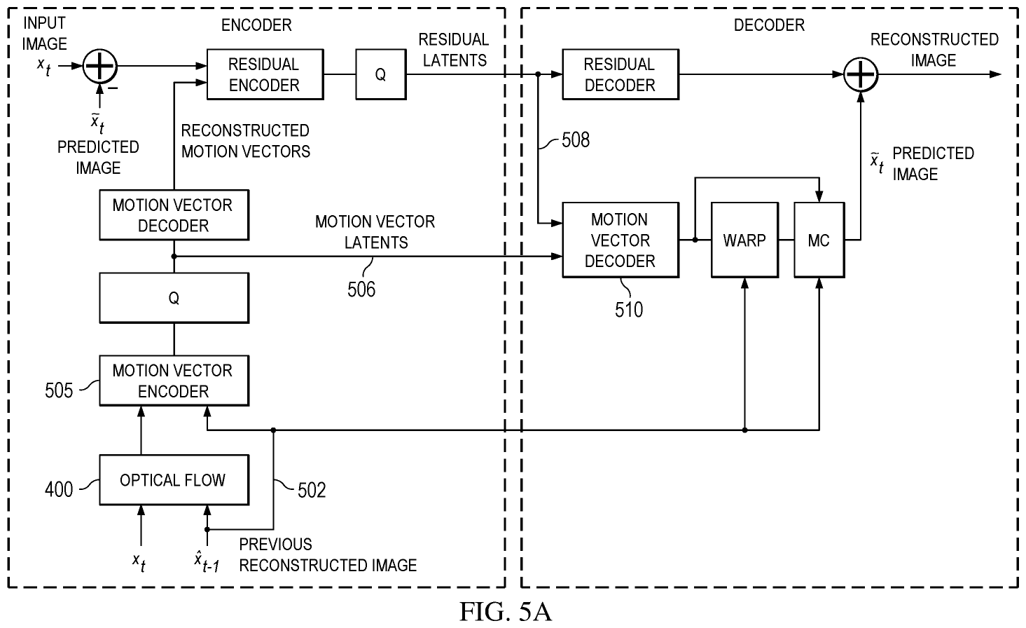

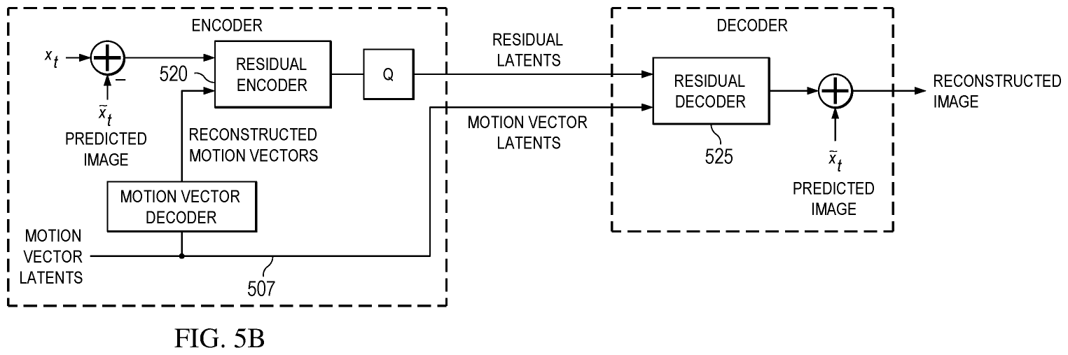

In an embodiment, it is proposed to use cross domain fusion for motion vector (MV) coding. In the embodiment depicted in FIG. 5A, the previous frame reconstructed samples (502) are used to enhance MV coding (505) at the encoder using optical flow (e.g., as in block 400). At the decoder, the previous frame residual latent values (508) are additionally used for MV compensation (MC) of the current frame to exploit cross dependencies of motion on residue. The motion vector decoder block (510) applies cross domain fusion using previous frame residual latents (508) and motion vector latents (506). The Motion vector encoder (505) applies cross domain fusion based on the previous frame image (502) as an additional input to the motion vector encoding process. The fusion is done in the latent domain at the decoder and in the spatial domain at the encoder. This fusion method tries to exploit any cross dependency of current frame motion on the intensity of the current image or the residue image. As an example, a non-zero residue at object boundaries is likely to coincide with motion boundaries, which can help improve coding efficiency of motion information.

In another embodiment, cross domain fusion may be applied in residue coding. As depicted in FIG. 5B, one can use reconstructed motion vectors to guide residual coding (520). At the decoder, the residual decoder (525) utilizes both motion vector latents (507) and residual latents. Residual decoder block (525) applies cross domain fusion by using current frame motion vector latents (507). The residual encoder (520) applies cross domain fusion using the current frame reconstructed motion as an additional input to the residue encoding process. The fusion is done in the latent domain at the decoder and in the spatial domain at the encoder. This fusion method tries to exploit any cross dependency of current frame residue on the current frame motion in the same region. As an example, a change in motion field at object boundaries is likely to coincide with non-zero residue which can help improve coding efficiency of residual information.

### Temporal and Spatial Prior-Based Entropy Coding

In an embodiment, it is desired to enable the entropy NN model to use features from a previous frame or from spatial neighbours. As in Ref. [8], the core idea is for the entropy model to estimate the spatiotemporal redundancy in a latent space rather than at the pixel level, which significantly reduces the complexity of the framework.

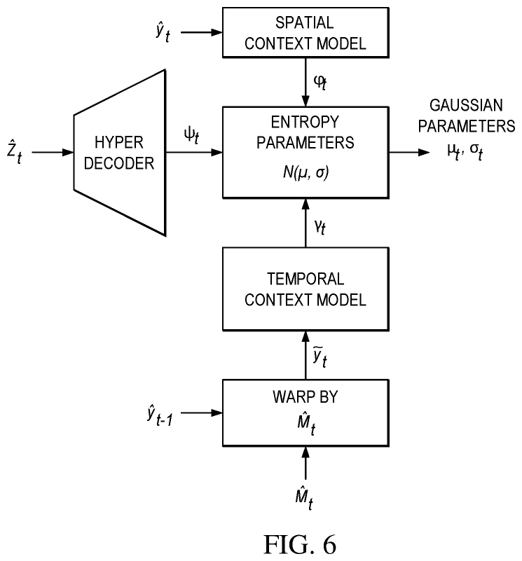

In inter-frame coding, the residual intensity map undergoes approximately the same motion as the current image. Since the encoder CNN network is shift invariant, the latent feature maps are also transformed by approximately the same motion, albeit, at magnitudes reduced by the down-sampling ratios undergone by the network layer. If one warps the previous frame's latent map of the residual by the image motion field, which is appropriately down-sampled and scaled, it would be a good prediction of the current latents to be transmitted. The entropy model of the latents can be conditioned on the predicted latents in addition to the hyper prior latents and the already decoded current frame latents. This should yield a significant reduction in the bits needed to transmit the residual latents. FIG. 6 depicts an example of the proposed entropy model with the addition of the temporal entropy model. Spatial context model uses decoded neighbour latent features ŷₜ of the current frame to estimate the spatial model parameters φₜ, Hyper-prior decoded features [symbol] are used to estimate the hyper-prior parameters ψₜ and latent features of previously decoded frames, ŷₜ₋₁ are warped (e.g., by using bilinear interpolation) using current frame decoded motion used to estimate the temporal prior features γₜ. These three features are jointly used to estimate the Gaussian or Laplace or multi-mixture model entropy model parameters such as mean and variance for the next latents of the current frame. One thing to note is that the current frame motion field \hat{M}ₜ needs to be scaled and downsampled to match the spatial resolution of the ŷₜ₋₁ latents.

### Training Improvement

To improve inter-frame coding efficiency, the following training procedures are proposed:
1) Large motion training: To handle large motion well, in the training steps, one needs to add large motion training using random P-frame skip from 1 to n−1, where n denotes the total frames in a training clip (e.g., n=7).
2) Temporal distance modulated loss: The idea is to use higher weight for far way P-frames:
   For temporal distance modulated loss, one may formulate rate-distortion (RD) loss as follows:

$$Loss = w * lambda * MSE + Rate ,$$

where Rate denotes achieved bit rate (e.g., bits per pixel) and MSE measures the L2 loss between an original frame and the reconstructed frame. Weight parameter “w” is initialized based on temporal distance (t) of the inter frame with following distance-based weightage:

$$w = \{ \begin{matrix}1 , & t = 0 ( Intraframe ) \\ min ( 1 , 0.2 * t + {w}_{i} ) , & for t \geq 1 ( inter frame ) , {w}_{i} ϵ [ 0 , 1 ]\end{matrix}$$

This weight wᵢ, where index i denotes iteration count (say, from 1 to 200k) is the same for each frame in a group of pictures (GOP) and is monotonically increased from 0 to 1 over a period of 200k iterations.
3) MV entropy modulated loss: The idea is to give higher weight to low probability latents (hard to code samples) compared to high probability latents. The motivation is taken from focal loss for object detection (Ref. [3]). In object detection, there is always an imbalance between background and foreground samples and a network always confuses between background and foreground. In Ref. [3], the authors propose a solution to this, where they apply a fixed weight to cross entropy loss to weigh hard samples more where hard samples are background samples in the image

In an embodiment, the formulation of weighted entropy loss is as follows:

$$Entropy loss = - log ( {p}_{t} )$$

$$Modulated Entropy loss = {( 1 - {p}_{t} )}^{b} * ( - log ( {p}_{t} ) ) ,$$

where,
   pₜ is the estimated probability of the latent symbol t
   b is monotonically reduced from 5.0 to 0.0 over a period of 200k iterations. At b=0, Modulated Entropy loss reduces to normal entropy loss.

The overall coding gain due to the improved training procedure is about 1.5% to 2.5%.

### Syntax Examples

The proposed tools may be communicated from an encoder to a decoder using high-level syntax (HLS) which can be part of the video parameter set (VPS), the sequence parameter set (SPS), the picture parameter set (PPS), the picture header (PH), the slice header (SH), or as part of supplemental metadata, like supplemental enhancement information (SEI) data. An example syntax is depicted in Table 1. Alternatively, if a specific architecture or tool is predetermined and known by both the encoder and the decoder, no such signaling may be required.

TABLE 1
An example of high-level syntax for inter coding adaptation

| | Descriptor |
|---|---|
| inter_coding_adaptation_syntax( payloadSize ) { | |
| inter_coding_adaptation_enabled_flag | u(1) |
| if( inter_coding_adaptation_enabled_flag ) { | |
| if( compress_domain == YUV) { | |
| joint_LC_MC_NN_enabled_flag | u(1) |
| joint_LC_residue_NN_enabled_flag | u(1) |
| } | |
| attention_layer_enabled_flag | u(1) |
| if (attention_layer_enabled_flag) { | |
| attention_layer_MV_enabled_flag | u(1) |
| attention_layer_residue_enabled_flag | u(1) |
| } | |
| temporal_motion_prediction_idc | ue(v) |
| if ( temporal_motion_prediction_idc ) | |
| num_ref_pics_minus1 | ue(v) |
| cross_domain_mv_enabled_flag | u(1) |
| cross_domain_residue_enabled_flag | u(1) |
| temporal_spatio_entropy_enabled_flag | u(1) |
| } | |
| } | |

inter_coding_adaptation_enabled_flag equal to 1 specifies inter coding adaptation is enabled for the decoded picture. inter_coding_adaptation_enabled_flag equal to 0 specifies inter coding adaptation is not enabled for the decoded picture.

joint_LC_MC_NN_enabled_flag equal to 1 specifies joint luma-chroma MC network is used to decode the signal in the YUV domain. joint_LC_MC_NN_enabled_flag equal to 0 specifies separate MC network is used to decode the signal in the YUV domain.

joint_LC_residue_NN_enabled_flag equal to 1 specifies joint luma-chroma residue network is used to decode the signal in the YUV domain.

joint_LC_residue_NN_enabled_flag equal to 0 specifies separate residue network is used to decode the signal in the YUV domain.

attention_layer_enabled_flag equal to 1 specifies attention layer is enabled for the decoded picture. attention_layer_enabled_flag equal to 0 specifies attention layer is not enabled for the decoded picture.

attention_layer_MV_enabled_flag equal to 1 specifies attention layer is enabled for the MV decoding. attention_layer_MV_enabled_flag equal to 0 specifies attention layer is not enabled for the MV decoding.

attention_layer_residue_enabled_flag equal to 1 specifies attention layer is enabled for the residue decoding. attention_layer_residue_enabled_flag equal to 0 specifies attention layer is not enabled for the residue decoding.

temporal_motion_prediction_ide equal to 0 specifies temporal motion prediction net module is not used for decoding motion vectors. temporal_motion_prediction_ide equal to 1 specifies temporal motion prediction with simple concatenation net module is used for decoding motion vectors. temporal_motion_prediction_idc equal to 2 specifies temporal motion prediction net module with warping the reference picture is used for decoding motion vectors.

num_ref_pics_minus1 plus 1 specifies the number of reference pictures used for temporal motion prediction net module.

cross_domain_mv_enabled_flag equal to 1 specifies cross domain net is enabled for decoding the motion vectors. cross_domain_mv_enabled_flag equal to 0 specifies cross domain net is not enabled for decoding the motion vectors.

cross_domain_residue_enabled_flag equal to 1 specifies cross domain net is enabled for decoding the residue. cross_domain_residue_enabled_flag equal to 0 specifies cross domain net is not enabled for decoding the residue.

temporal_spatio_entropy_idc equal to 0 specifies neither temporal nor spatial feature is used for entropy decoding in inter frames. temporal_spatio_entropy_idc equal to 1 specifies only spatial features is used for entropy decoding in inter frames.

temporal_spatio_entropy_idc equal to 2 specifies only temporal features is used for entropy decoding in inter frames. temporal_spatio_entropy_idc equal to 3 specifies both temporal and spatial features are used for entropy decoding in inter frames.

### Weighted Motion-Compensated Inter Prediction

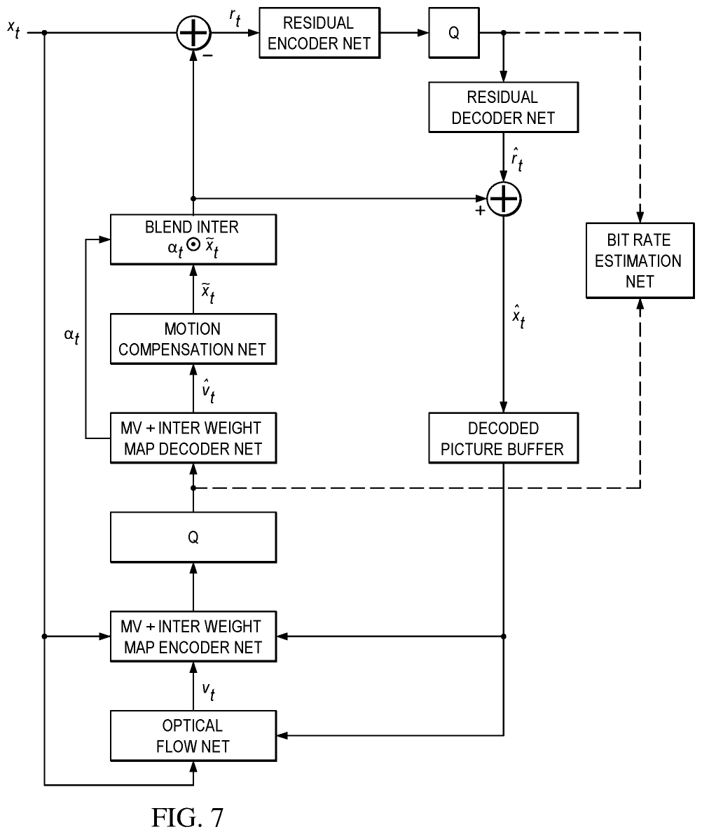

FIG. 7 depicts an example process for weighted motion-compensated prediction according to an embodiment. Compared to FIG. 1, FIG. 7 depicts the following changes: replacing the MV encoder network with an MV+inter-weight map encoder network, replacing the MV decoder network with an MV+inter-weight map decoder network, and adding a “Blend Inter” network.

The motivation of this architecture is to allow both intra and inter coding in inter frames, without explicit signalling of a binary intra/inter flag used in conventional block-based coding. The explicit binary mode signalling is easier in conventional block-based codec, but may not be straight forward and effective for a deep learning-based codec which codes spatially overlapping features in the latent domain.

Instead of using a binary intra/inter coding flag, the basic idea here is to code an explicit spatial weight-map along with motion information. These weights are applied as point-wise blending factors (α or αₜ) (with a in [0, 1]), for the motion compensated (MC) inter prediction samples ( [symbol] ) followed by residual coding (rₜ), as shown in FIG. 7, where
xₜ is the source frame (uncompressed input)
vₜ is the estimated uncompressed motion flow on the encoder side
[symbol] is the reconstructed motion flow output by MV Decoder Net
α is the spatial weight map coded along with motion information (output by MV Decoder Net)
[symbol] is the motion compensated (MC) inter prediction frame derived from the compressed flow using forward warping of reference frame and the Motion Compensation Net
α⊙ [symbol] denotes the weighted MC inter prediction frame by doing pointwise multiplication of the motion compensated samples with respective alpha weights
rₜ is the residual signal after subtracting the weighted MC frame from the source
[symbol] is the reconstructed residue on the decoder side after quantization and synthesis of residual latents
[symbol] is the reconstructed frame after adding the reconstructed residue [symbol] with the weighted MC inter prediction

The process of weighted motion compensated prediction can be expressed as:

$${r}_{t} = {x}_{t} - α ⊙ ; \qquad a .$$

$$= {g}_{s} ( ⌊ {g}_{a} ( {r}_{t} ) ⌋ ) ; and \qquad b .$$

$$= α ⊙ + , \qquad c .$$

where gₐ and gₛ are residual encoder analysis (e.g., residual encoder net in FIG. 1 and FIG. 7) and residual decoder synthesis networks (e.g., residual decoder net) (Ref. [1]).

Note that the motion latents carry information for both compressed flow and the spatial weight map.

The output of the motion compression network also includes the spatial weight map (α or αₜ) which is used for blending the motion compensation before residual compression. The residual is the difference between the original frame and the motion compensation pixel scaled by alpha at pixel resolution level.

When α is unity, the decoded flow and corresponding MC inter prediction is highly reliable, hence the residual is purely inter-coded. When α is zero, the decoded flow and corresponding MC inter prediction is highly unreliable, hence the residual is purely intra-coded. Mix of intra and inter information can be coded when α is between 0 and 1 based on quality of the inter prediction, which is analogous to combined intra-inter prediction (CIIP) used in a conventional codec, like VVC.

The network is trained in end-to-end manner for a joint Rate-Distortion (RD) loss function, e.g., Loss=lambda*MSE+Rate, during which the network parameters for optimal coding of motion information, alpha weights, and residual information are learnt using stochastic gradient descent algorithms such as the ADAM optimizer. This network is trained for a large video dataset such as Vimeo-90k, using a batch size of 4, 8 or 16. A network trained on a generalized video dataset may not fully comprehend a selection of RD optimal motion information, alpha weights, and residual information for an actual source content under test. In an embodiment, this can be mitigated by content specific encoder optimization, say, by overfitting the encoder network or the coded latents for a given source video by iterative refinement procedure. This can help in optimizing the alpha weights, the motion information, and the residual information to minimize the RD loss for a given content under test for increased encoder complexity.

To train and code the spatial weight map accurately, additional inputs are included (augmented) in the motion and alpha compression network (e.g., MV+Inter Weight Map Encoder Net), such as: using a previous reconstructed reference frame, using the current original input frame, and using a warped reference frame generated using uncompressed optical flow motion vectors. The warping process is not shown in the figure for simplicity.

The residual compression architecture remains same as in previous version of DLVC (e.g., see FIG. 1). For motion compensation blending, as discussed earlier, to improve training, instead of a warped frame, other variations can also be done by passing this information to a decoder, say by using the argument of syntax variable mv_aug_type, for example, with the following options:
1. mv_aug_type=prev_com_res: a previous frame (a reference frame) and residual latents of the reference frame are used as augmented input
2. mv_aug_type=input: the source frame (input), a reference frame and reference frame residual latents are used as augmented input
3. mv_aug_type=warp: the source frame (input), a reference frame, a warped ref frame (using uncompressed flow) and residual latents of the reference frame are used as augmented inputs
4. mv_aug_type=mc: the source frame (input), a reference frame, the motion-compensated reference frame (using uncompressed flow), and residual latents of the reference frame are used as augmented inputs

Experimental results show that the proposed scheme may improve compression efficiency over DLVC v. 4.4 (Ref. [1]) by at least 2% and up to 5%, depending on the class of test images.

### REFERENCES

Each one of the references listed herein is incorporated by reference in its entirety.
[1] Guo Lu et al., “DVC: An end-to-end deep video compression framework,” Proceedings of the IEEE Conference on Computer Vision and Pattern Recognition (CVPR). 2019.
[2] Z. Guo et al., “Soft then Hard: Rethinking the Quantization in Neural Image Compression,” Proceedings of ICML 2021, arXiv: 2104.05168v1, 12 Apr. 2021.
[3] Tsung-Yi Lin et al., “Focal Loss for Dense Object Detection,” IEEE Transactions on Pattern Analysis and Machine Intelligence,” 2018, arXiv: 1708.02002v2, 7 Feb. 2018.
[4] Z. Hu et al., “FVC: A New Framework towards Deep Video Compression in Feature Space,” IEEE/CVF Conference on Computer Vision and Pattern Recognition, 2021, arXiv: 2105.09600v1, 20 May 2021.
[5] A. K. Singh et al., “A Combined Deep Learning based End-to-End Video Coding Architecture for YUV Color Space,” CVPR 2021, arXiv: 2104.00807v1, Apr. 1, 2021.
[6] H. E. Egilmez et al., “Transform Network Architectures for Deep Learning based End-to-End Image/Video Coding in Subsampled Color Spaces,” arXiv: 2103.01760v1, 27 Feb. 2021.
[7] A. Mohananchettiar et al., “Multi-level latent fusion in neural networks for image and video coding,” U.S. Provisional Patent Application Ser. No. 63/257,388, filed on Oct. 19, 2021.
[8] Z. Sun et al., “Spatiotemporal entropy model is all you need for learned video compression,” arXiv: 2104.06083 (2021).
[9] Z. Cheng et al., “Learned Image Compression with Discretized Gaussian Mixture Likelihoods and Attention Modules,” CVPR 2020, arXiv: 2001.01568v3, 30 Mar. 2020.

### Example Computer System Implementation

Embodiments of the present invention may be implemented with a computer system, systems configured in electronic circuitry and components, an integrated circuit (IC) device such as a microcontroller, a field programmable gate array (FPGA), or another configurable or programmable logic device (PLD), a discrete time or digital signal processor (DSP), an application specific IC (ASIC), and/or apparatus that includes one or more of such systems, devices or components. The computer and/or IC may perform, control, or execute instructions relating to inter-frame coding using neural networks for image and video coding, such as those described herein. The computer and/or IC may compute any of a variety of parameters or values that relate to inter-frame coding using neural networks for image and video coding described herein. The image and video embodiments may be implemented in hardware, software, firmware and various combinations thereof.

Certain implementations of the invention comprise computer processors which execute software instructions which cause the processors to perform a method of the invention. For example, one or more processors in a display, an encoder, a set top box, a transcoder, or the like may implement methods related to inter-frame coding using neural networks for image and video coding as described above by executing software instructions in a program memory accessible to the processors. Embodiments of the invention may also be provided in the form of a program product. The program product may comprise any non-transitory and tangible medium which carries a set of computer-readable signals comprising instructions which, when executed by a data processor, cause the data processor to execute a method of the invention. Program products according to the invention may be in any of a wide variety of non-transitory and tangible forms. The program product may comprise, for example, physical media such as magnetic data storage media including floppy diskettes, hard disk drives, optical data storage media including CD ROMs, DVDs, electronic data storage media including ROMs, flash RAM, or the like. The computer-readable signals on the program product may optionally be compressed or encrypted.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (e.g., that is functionally equivalent), including components which are not structurally equivalent to the disclosed structure which performs the function in the illustrated example embodiments of the invention.

### EQUIVALENTS, EXTENSIONS, ALTERNATIVES AND MISCELLANEOUS

Example embodiments that relate to inter-frame coding using neural networks for image and video coding are thus described. In the foregoing specification, embodiments of the present invention have been described with reference to numerous specific details that may vary from implementation to implementation. Thus, the sole and exclusive indicator of what is the invention, and what is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method to process with one or more neural-networks a coded video sequence, the method comprising:
receiving high-level syntax indicating that inter-coding adaptation is enabled for decoding a current picture;
parsing the high-level syntax for extracting inter-coding adaptation parameters; and
decoding the current picture based on the inter-coding adaptation parameters to generate an output picture, wherein the inter-coding adaptation parameters comprise one or more of:
a joint luma-chroma motion compensation enabled flag, indicating that a joint luma-chroma motion compensation network is used in decoding when input pictures are in a YUV color domain;
a joint luma-chroma residual coding enabled flag, indicating that a joint luma-chroma residue network is used in decoding when the input pictures are in the YUV color domain;
an attention layer enabled flag indicating that attention network layers are used in decoding;
a temporal motion prediction enabled flag, indicating that temporal motion prediction networks are used for motion vector prediction in decoding;
a cross-domain motion vector enabled flag, indicating that a cross-domain network which combines motion vector and residue information is used to decode motion vectors in decoding;
a cross-domain residue enabled flag, indicating that a cross-domain network which combines motion vector and residue information is used to decode residuals in decoding; and
a temporal-spatial-entropy flag indicating whether entropy decoding uses only spatial features, only temporal features, or a combination of spatial and temporal features.

2. The method of claim 1, wherein when joint luma-chroma motion compensation is enabled,
a motion compensated luma component (\tilde{y}ₜ) and chroma components ( [symbol] ₜ) of the current picture are generated using a joint luma-chroma motion compensation network with inputs comprising:
decoded motion (\hat{M}ₜ) of the current picture, luma component (ŷₜ₋₁) of a prior reference picture, a bilinear interpolated luma prediction picture, denoted by warp (ŷₜ₋₁, \hat{M}ₜ), chroma components ( [symbol] ₜ₋₁) of the prior reference picture, and a bilinear interpolated chroma prediction component denoted by warp ( [symbol] ₜ₋₁, \hat{M}ₜ/2) using down sampled and down scaled chroma motion (\hat{M}ₜ/2).

3. The method of claim 1, wherein when attention network layers are used, when decoding P or B pictures, attention blocks layers are inserted in between two deconvolution layers, each deconvolution layer comprising a deconvolution layer with up-sampling, followed by a non-linear activation block.

4. The method of claim 3, wherein an attention block layer is inserted after two consecutive deconvolution layers with no attention block between them or after each deconvolution layer.

5. The method of claim 1, wherein when temporal motion prediction networks are used for motion vector prediction, a flow prediction neural network comprises:
a flow buffer receiving decoded flow information, followed by a first convolutional 2D network, followed by a series of one or more ResBlock 64 layers, followed by a second convolutional 2D network.

6. The method of claim 5, wherein for P pictures, generating output motion (\hat{M}ₜ) for the current picture in the decoder comprises:
using decoded flow motion (\hat{M}ₜ₋₁, \hat{M}ₜ₋₂, and \hat{M}ₜ₋₃) of three past reference pictures as input to the flow prediction network to generate a first output;
receiving a quantized delta motion value from an encoder;
processing the quantized delta motion value using a motion vector decoder network to generate an input motion prediction value; and
adding the first output to the input motion prediction value to generate the output motion vector for the current picture,
wherein, in the encoder, generating the quantized delta motion value comprises:
using a current picture (Xₜ), a reference picture (\hat{X}ₜ₋₁), and a motion estimation block to generate a second output;
subtracting the first output from the second output to generate a delta output; and
processing the delta output through a motion vector coding network followed by quantization to generate the delta motion value.

7. The method of claim 5, wherein for B pictures, generating output motion (\hat{M}ₜ) for the current picture in the decoder comprises:
using decoded flow motion (\hat{M}ₜ₋₂, \hat{M}ₜ₋₁, and \hat{M}ₜ₊₁) of two past reference pictures and one future reference picture as input to the flow prediction network to generate a first output;
receiving a quantized delta motion value from an encoder;
processing the quantized delta motion value using a motion vector decoder network to generate an input motion prediction value; and
adding the first output to the input motion prediction value to generate the output motion vector for the current picture,
wherein, in an encoder, generating the quantized delta motion value comprises:
using a current picture (Xₜ), reference pictures (\hat{X}ₜ₋₁ and \hat{X}ₜ₊₁), and a motion estimation block to generate a second output;
subtracting the first output from the second output to generate a delta output; and
processing the delta output through a motion vector coding network followed by quantization to generate the delta motion value.

8. The method of claim 6, wherein the input to the flow prediction network is preceded by a warping network, the warping network comprising:
a first network with motion vector inputs (\hat{M}ₜ₋₂ and \hat{M}ₜ₋₁) to generate an output that reverse warps \hat{M}ₜ₋₂ by \hat{M}ₜ₋₁;
a concatenation network to concatenate \hat{M}ₜ₋₁ and the output of the first network to generate a concatenation network output; and
a second network which generates the input to the flow prediction network by forward warping by −\hat{M}ₜ₋₁ the concatenation network output.

9. The method of claim 1, wherein when a cross-domain network is used to decode motion vectors, decoding comprises:
receiving from an encoder residual latents and motion vector latents;
combining the residual latents and the motion vector latents in a motion vector decoder network to generate motion vectors to be used for motion compensation, wherein generating the motion vector latents in the encoder comprises:
using pixel values of the current picture and a prior reference picture as inputs to an optical flow network and a motion vector encoder network to generate the motion vector latents.

10. The method of claim 1, wherein when a cross-domain network is used to decode residuals, decoding comprises:
receiving from an encoder residual latents and motion vector latents; and
combining the residual latents and the motion vector latents in a residual decoder network to generate residual pixel values, wherein generating the residual latents in the encoder comprises:
accessing residual pixel values of the current picture and a prior reference picture;
accessing motion vector latents;
applying a motion vector decoder to the motion vector latents to generate reconstructed motion vectors; and
generating the residual latents based on the residual pixel values and the generated reconstructed motion vectors.

11. The method of claim 1, wherein when entropy decoding uses spatiotemporal features, entropy decoding comprises:
applying decoded neighbour latent features (ŷₜ) of the current picture to a spatial context model to generate estimates of spatial model parameters (φₜ);
applying hyper-prior decoded features ( [symbol] ) to a Hyper decoder to estimate hyper-prior parameters (ψₜ);
applying latent features of previously decoded pictures (ŷₜ₋₁) and decoded motion from the current picture to a warping block to estimate temporal prior features (γₜ); and
generating entropy model parameters for subsequent latents based on the spatial model parameters, the temporal prior features, and hyper-prior parameters.

12. A method to improve training of neural networks employed in inter-frame coding, the method comprising one or more of:
large motion training, wherein for training sequences with n total pictures, large motion training is employed using a random P-frame skip from 1 to n−1;
temporal distance modulated loss, wherein in computing rate-distortion loss as
$$Loss = w * lambda * MSE + Rate ,$$
where Rate denotes achieved bit rate and MSE measures a distortion between an original picture and a corresponding reconstructed picture, weight parameter “w” is initialized based on temporal inter frame distance as:
$$w = \{ \begin{matrix}1 , & t = 0 ( Intraframe ) \\ min ( 1 , 0.2 * t + {w}_{i} ) , & for t \geq 1 ( inter frame ) , {w}_{i} ϵ [ 0 , 1 ]\end{matrix} ,$$
where index i denotes iteration count over N training iterations.

13. The method of claim 12, wherein computing modulated entropy loss comprises:
$$Modulated Entropy loss = {( 1 - {p}_{t} )}^{b} * ( - log ( {p}_{t} ) ) ,$$
wherein,
pₜ denotes estimated probability of latent symbol t, and
b is monotonically reduced from 5.0 to 0.0 over the N training iterations.

14. A method to process with one or more neural-networks uncompressed video frames, the method comprising:
generating motion vector and spatial map information (α) for an uncompressed input video frame (xₜ) based on a sequence of uncompressed input video frames that include the uncompressed input video frame;
generating a motion-compensated frame ( [symbol] ) based at least on a motion compensation network and reference frames used to generate the motion vector information;
applying the spatial map information to the motion-compensated frame to generate a weighted motion-compensated frame;
generating a residual frame by subtracting the weighted motion-compensated frame from the uncompressed input video frame;
generating a reconstructed residual frame ( [symbol] ) based on residual encoder analysis and a decoder synthesis network, wherein the residual encoder analysis network generates an encoded frame based on a quantization of the residual frame; and
generating a decoded approximation of the encoded frame by adding the weighted motion-compensated frame to the reconstructed residual frame.

15. The method of claim 14, wherein the spatial map information comprises weights in [0, 1], wherein 0 indicates a preference for intra-only coding and 1 indicates a preference for inter-only coding and weights between 0 and 1 represent blended intra-inter coding.

16. A non-transitory computer-readable storage medium having stored thereon computer-executable instructions for executing with one or more processors a method in accordance with claim 1.

17. An apparatus comprising a processor and configured to perform the method recited in claim 1.
